(19) United States
(12) Patent Application Publication
(10) Pub. No.: US 2011/0017562 A1
(43) Pub. Date: Jan. 27, 2011

(54) VIBRATION DAMPING SYSTEM FOR UTILITY POLES

(75) Inventors: Bobby J. BENNETT, Piney Flats, TN (US); Gregory D. MERCIER, Bristol, VA (US)

Correspondence Address: BUCHANAN, INGERSOLL & ROONEY PC, POST OFFICE BOX 1404, ALEXANDRIA, VA, 22313-1404, US

(73) Assignee: HAPCO ALUMINUM POLE PRODUCTS, Abingdon, VA (US)

(21) Appl. No.: 12/506,416

(22) Filed: Jul. 21, 2009

(51) Int. Cl. F16F 7/10

(52) U.S. Cl. 188/379

(57) ABSTRACT

A vibration damping mechanism for utility poles includes a cylindrical hollow tube including a sidewall having outer and inner side surfaces. The inner side surface forms an elongated inner chamber defining a longitudinal axis and having longitudinally spaced upper and lower ends. An unrestricted cylindrical rod disposed in the chamber is capable of limited movement in the chamber to damp oscillations. A section of the tube's sidewall is flat to form vertical flats along the outer and inner side surfaces. Formed portions of the sidewall disposed at respective upper and lower ends of the chamber are bent inwardly to extend across, and close, the upper and lower chamber ends, respectively. The lower one of the formed portions is shaped to define a raised pivot engaging a bottom face of the rod at a location laterally inwardly of the rod's outer side face.

### BACKGROUND

This disclosure relates to the vibration damping of elongated utility poles such as light poles, flagpoles, traffic signal poles, and the like.

Internal vibrations of vertical utility poles for supporting luminaries and the like which are created by environmental forces acting on such poles, have caused many instances of mechanical failure of the pole and/or the luminaire or other item supported by the pole. For example, such vibrations frequently result in eventual failure of tubular metal poles due to metal fatigue. Moreover, internal vibrations of this type frequently result in mechanical damage to the luminaire and its associated structure supported on the poles. For example, fittings and couplings may be eventually loosened by the vibration, and the electrical components of the luminaire may also be damaged to such an extent as to become inoperative.

Mechanisms for damping such internal vibrations in utility poles have been heretofore proposed, for example, in U.S. Pat. Nos. 3,612,222; 4,130,185: 4,350,233; and 6,234,286. Another prior art damping mechanism is depicted in accompanying FIGS. 1-3. That damping mechanism comprises an elongated aluminum tube 10 that is hollow on its interior to provide a closed chamber in which a substantially high-mass rod 12 is mounted. The closed chamber and the rod are of cylindrical shape with a fairly small amount of clearance provided therebetween. Consequently, the rod is free to make limited movement within the rod to dampen movement of the tube and thus of the pole P to which it is attached. The tube has angle elements 16 attached at its respective ends, each including horizontal and vertical sections 16a and 16b. The horizontal section 16a extends across and closes the end of the chamber. The vertical section 16b has a through-hole 17 for receiving a fastener to connect the tube to either the exterior or interior of the pole, depending upon the particular requirements of the pole installation. Plastic caps 18 are fitted over the ends of the rod member to lessen the noise occasioned by the vibration of the tube member with respect to the rod and vice versa. A pair of inwardly projecting, vertically spaced dimples 20 are formed on the inner surface of the tube for preventing spinning or rolling movement of the rod around the inside of the chamber, which movement can adversely affect the damping performance. Although such a damping mechanism has heretofore functioned successfully, room for improvement remains as explained below.

### SUMMARY

A vibration damping mechanism for elongated poles comprises a generally cylindrical hollow tube including a sidewall having outer and inner side surfaces. The inner side surface forms an elongated inner chamber defining a longitudinal axis and having longitudinally spaced upper and lower ends. An unrestricted inertia mass member comprising a substantially cylindrical rod is disposed in the chamber. The inner side surface provides limited clearance with respect to an outer side face of the rod, wherein the rod is capable of limited movement in the chamber to damp oscillations. A section of the outer side surface of the sidewall is substantially flat along substantially the entire longitudinal extent of the sidewall.

Additionally or optionally, the flat section of the outer surface is formed by a flat portion of the sidewall which also forms a flat section of the inner side surface.

Additionally or optionally, formed portions of the sidewall disposed at respective upper and lower ends of the chamber are bent inwardly to extend across, and close, the upper and lower chamber ends, respectively.

Additionally or optionally, the formed portion disposed at the chamber's lower end is shaped to define a raised pivot engaging a bottom face of the rod at a location laterally inwardly of the rod's outer side face.

### DESCRIPTION OF THE DRAWINGS

FIG. 1 is a side elevational view of one side of a prior art pole-damping mechanism.

FIG. 2 is a bottom plan view of the prior art mechanism shown in FIG. 1.

FIG. 3 is a fragmentary side view of a bottom end of the prior art mechanism shown in FIG. 1.

FIG. 4 is a side elevational view of one side of an improved damping mechanism attached to an exterior of a pole.

FIG. 5 is a side elevational view of another side of the improved damping mechanism displaced by 90 degrees from the side shown in FIG. 4.

FIG. 6 is a top plan view of the improved damping mechanism, with the interior surface of a pole shown in broken lines.

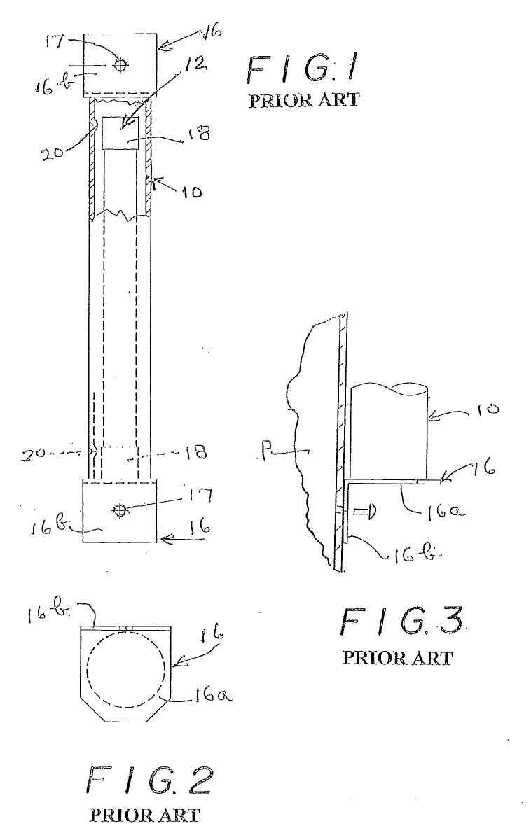

### DETAILED DESCRIPTION OF A PREFERRED EMBODIMENT

A vibration damping mechanism 20 for elongated poles comprises a generally cylindrical hollow metal (e.g., aluminum) tube 22 which includes a sidewall 24 having outer and inner side surfaces 26, 28. The inner side surface forms an elongated inner chamber 30 defining a longitudinal axis A and having longitudinally spaced upper and lower ends 32, 34. An inertia mass member comprising a substantially cylindrical rod 38 is disposed in the chamber. The tube's inner surface 28 provides limited clearance with respect to an outer side face 42 of the rod, and the rod is not attached to the tube, so the rod is unrestricted and thus capable of limited movement in the chamber to damp oscillations of the tube and the vertical pole P to which the tube is attached. The rod has plastic caps 43 fitted on its respective ends to minimize noise.

The sidewall 24 includes a flat first portion 50 which is flat along the entire longitudinal extent of the sidewall to define both an outer flat section 52 of the outer side surface 26 and an inner flat section 54 of the inner side surface 28.

By forming the flat 52 along the tube's outer side surface 26, the tube, when attached to an interior surface S of the pole, as is usually the case (see FIG. 6), will have its longitudinal axis A located closer to that interior surface than would otherwise be the case if the outer surface of the tube had no flat. Thus, the tube occupies less of the interior cross section of the pole. That is important, especially in small-diameter poles, because it means that the mechanism 20 will create less of an impedance to the passage of wiring through the pole.

The flat 54 formed on the inner side surface 28 of the tube functions to resist spinning or rolling of the rod along that surface. It has been found that such spinning can adversely affect the damping performance.

The tube's sidewall 24 further includes formed second and third portions 60, 62 disposed at respective upper and lower ends of the chamber and radially opposite the flat portion 50. Each of the formed second and third portions is bent (mechanically deformed) inwardly so that an axially innermost section 60a, 62a thereof extends across, and generally closes, the upper and lower chamber ends, respectively. Each bent portion forms a recess 66 in the sidewall 24 that has a width W (FIG. 5) becoming narrower in a direction toward the opposite end of the chamber.

Each of the axially innermost sections 60a, 62a is inclined toward the respective opposite end of the chamber (i.e., the sections 60a, 62a are inclined toward one another) at an angle α with respect to horizontal. The angle α is preferably about 5 degrees with a tolerance of 0 degrees to minus 30 minutes. As a result, the free end or tip of the bottom one 62a of the axially innermost sections makes substantially point contact with the bottom face 64 of the rod, i.e., it defines a raised pivot engaging the bottom face of the rod at a location laterally inwardly of the rod's outer side face 42.

The provision of formed portions 60, 62 at the ends of the tube eliminates the need for separate elements, such as caps and angle members, to close off the tube ends, thereby reducing cost. By shaping at least the lower bent portion 62 to serve as a a raised pivot for the weight to rest upon, the weight is able to move more freely in response to smaller pole vibration displacement. Such facilitated movement enables the damper to intervene earlier in a pole's vibration event.

The damping mechanism 20 is configured symmetrically about a horizontal center line so that it can be installed with either of its ends defining the bottom end. Thus, if the mechanism were inverted from the orientation shown in the figures, the formed section 60a would define the raised pivot for the rod.

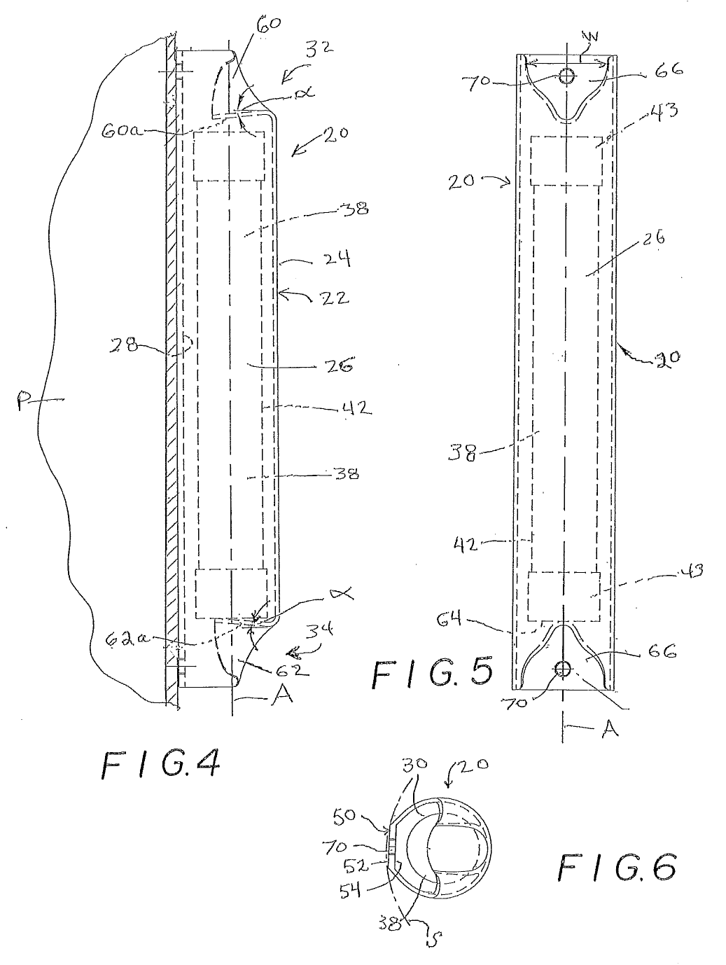

The recesses 66 formed in the sidewall 24 serve to expose portions of the flat portion 50. That facilitates mounting of the tube to a pole, because holes 70 are formed through the flat portion 50 in alignment with respective ones of the recesses to accommodate fasteners, such as bolts or screws (not shown) for attaching the tube to the pole P. The tube can be attached to either an exterior surface of the pole as shown in FIG. 4, or to an interior surface S thereof (see the broken lines in FIG. 6).

In summary, it will be appreciated that the improved damping mechanism having formed end sections on the tube eliminates the need for separately attaching additional elements, such as angle members, to the tube's ends. The flat formed on the tube's inner surface eliminates the need to form dimples to prevent spinning of the rod. The flat formed on the tube's outer surface enables the tube to occupy less of the tube's inner volume and thereby minimizes interference with internal wiring. The raised pivot for supporting the rod facilitates early movement and damping action of the rod.

While there has been described a preferred embodiment of the improved damping mechanism, it will be appreciated that modifications and changes can be made by those skilled in the art without departing from the spirit of the improvements, and it is intended that the following claims cover such modifications and changes.

What is claimed is:

1. A vibration damping mechanism for elongated poles, comprising a generally cylindrical hollow tube including a sidewall having outer and inner surfaces, said inner surface forming an elongated inner chamber defining a longitudinal axis and having longitudinally spaced upper and lower ends; an unrestricted inertia mass member comprising a substantially cylindrical rod disposed in said chamber; said inner surface providing limited clearance with respect to an outer side face of said rod, wherein said rod is capable of limited movement in said chamber to damp oscillations; said sidewall including a flat first portion which is substantially flat along substantially the entire longitudinal extent of said sidewall to define an outer flat section of said outer surface and an inner flat section of said inner surface; said sidewall further including formed second and third portions disposed at respective upper and lower ends of said chamber and opposite said flat portion; each of said second and third portions being bent inwardly to extend across said upper and lower chamber ends, respectively; said third portion being shaped to define a raised pivot engaging a bottom face of said rod at a location laterally inwardly of said rod's outer side face.

2. The vibration damping mechanism according to claim 1, wherein said second and third bent portions form respective recesses in said sidewall, first and second fastener-receiving holes formed through said flat portion of said sidewall in alignment with said recesses.

3. The vibration damping mechanism according to claim 1, wherein an axially inner section of said formed third portion is inclined toward the opposite end of said chamber form said raised pivot which makes point contact with said rod's bottom face.

4. A vibration damping mechanism for elongated poles, comprising a generally cylindrical hollow tube including a sidewall having outer and inner surfaces, said inner surface forming an elongated inner chamber defining a longitudinal axis and having longitudinally spaced upper and lower ends; an unrestricted inertia mass member comprising a substantially cylindrical rod disposed in said chamber; said inner surface providing limited clearance with respect to an outer side surface of said rod, wherein said rod is capable of limited movement in said chamber to damp oscillations; a section of said outer surface of sidewall being substantially flat along substantially the entire longitudinal extent of said sidewall.

5. The vibration damping mechanism according to claim 4, wherein said flat section of said outer surface is formed by a flat portion of said sidewall which also forms a flat section of said inner surface for resisting spinning of said rod within said chamber.

6. The vibration damping mechanism according to claim 5, wherein formed portions of said sidewall disposed at respective upper and lower ends of said chamber are bent inwardly to extend across said upper and lower chamber ends, respectively.

7. The vibration damping mechanism according to claim 6, wherein said formed portions define recesses in said sidewall which are disposed laterally opposite said flat portion, said flat portion having through-holes formed therein in alignment with respective recesses for receiving fasteners.

8. The vibration damping mechanism according to claim 5, wherein said formed portion disposed at said lower end being shaped to define a raised pivot engaging a bottom face of said rod at a location laterally inwardly of said rod's outer side face.

9. The vibration damping mechanism according to claim 4, wherein a formed portion of said sidewall disposed at a lower end of said chamber is bent inwardly to extend across said lower chamber end and is shaped to define a raised pivot engaging a bottom face of said rod at a location laterally inwardly of said rod's outer side face.

10. The vibration damping mechanism according to claim 4, wherein formed portions of said sidewall disposed at respective upper and lower ends of said chamber are bent inwardly to extend across said upper and lower chamber ends, respectively.

11. The vibration damping mechanism according to claim 10, wherein said formed portion disposed at said lower end being shaped to define a raised pivot engaging a bottom face of said rod at a location laterally inwardly of said rod's outer side face.

12. A vibration damping mechanism for elongated poles, comprising a generally cylindrical hollow tube including a sidewall having outer and inner surfaces, said inner surface forming an elongated inner chamber defining a longitudinal axis and having longitudinally spaced upper and lower ends; an unrestricted inertia mass member comprising a substantially cylindrical rod disposed in said chamber; said inner surface providing limited clearance with respect to an outer side surface of said rod, wherein said rod is capable of limited movement in said chamber to damp oscillations; a section of said inner surface of sidewall being substantially flat along substantially the entire longitudinal extent of said sidewall.

13. The vibration damping mechanism according to claim 12, wherein formed portions of said sidewall disposed at respective upper and lower ends of said chamber are bent inwardly to extend across said upper and lower chamber ends, respectively.

14. The vibration damping mechanism according to claim 13, wherein said formed portion disposed at said lower end is shaped to define a raised pivot engaging a bottom face of said rod at a location laterally inwardly of said rod's outer side face.

15. The vibration damping mechanism according to claim 12, wherein a formed portion of said sidewall disposed at a lower end of said chamber is bent inwardly to extend across said lower chamber end and shaped to define a raised pivot engaging a bottom face of said rod at a location laterally inwardly of said rod's outer side face.

16. A vibration damping mechanism for elongated poles, comprising a generally cylindrical hollow tube including a sidewall having outer and inner surfaces, said inner surface forming an elongated inner chamber defining a longitudinal axis and having longitudinally spaced upper and lower ends; an unrestricted inertia mass member comprising a substantially cylindrical rod disposed in said chamber; said inner surface providing limited clearance with respect to an outer face of said rod, wherein said rod is capable of limited movement in said chamber to damp oscillations; formed portions of said sidewall disposed at respective upper and lower ends of said chamber being bent inwardly to extend across said upper and lower chamber ends, respectively.

17. The vibration damping mechanism according to claim 16, wherein said formed portion disposed at said lower end being shaped to define a raised pivot engaging a bottom face of said rod at a location laterally inwardly of said rod's outer side face.

18. A vibration damping mechanism for elongated poles, comprising a generally cylindrical hollow tube including a sidewall having outer and inner surfaces, said inner surface forming an elongated inner chamber defining a longitudinal axis and having longitudinally spaced upper and lower ends; an unrestricted inertia mass member comprising a substantially cylindrical rod disposed in said chamber; said inner surface providing limited clearance with respect to an outer face of said rod, wherein said rod is capable of limited movement in said chamber to damp oscillations; a formed portion of said sidewall disposed at a lower end of said chamber being bent inwardly to extend across said lower chamber end and shaped to define a raised pivot engaging a bottom face of said rod at a location laterally inwardly of said rod's outer side face.
